(19) United States
(12) Patent Application Publication
(10) Pub. No.: US 2006/0171264 A1
(43) Pub. Date: Aug. 3, 2006

(54) Servo system

(76) Inventors: Yu Zhou, Singapore (SG); Kunasilan Chinna Gounden, Singapore (SG)

Correspondence Address: PHILIPS INTELLECTUAL PROPERTY & STANDARDS, P.O. BOX 3001, BRIARCLIFF MANOR, NY, 10510, US

(21) Appl. No.: 10/564,532

(22) PCT Filed: Jul. 8, 2004
(86) PCT No.: PCT/IB04/51164

§ 371 Date: Jan. 12, 2006

(30) Foreign Application Priority Data
Jul. 17, 2003 (EP) 03102204.9

(51) Int. Cl. G11B 7/00

(52) U.S. Cl. 369/44.27

(57) ABSTRACT

There is provided a servo system for controlling position of a sensor assembly (30) in a data readout and/or writing device (10, 500). The device (10, 500) includes: (a) two actuators (28, 36) for spatially actuating a structural assembly (22) and its associated sensor assembly (30, 530), the system further comprising: (b) a servo control unit (34, 600) in communication with the two actuators (28, 36) for controlling spatial movement of the structural assembly (22) and the sensor assembly (30, 530). The controlling means (34) is operable: (c) to apply substantially velocity feedback control to the actuators (28, 36) when the sensor assembly (30, 530) is substantially remote from a desired target position; and (d) to apply substantially position feedback control to the actuators (28, 36) when the sensor assembly (30, 530) is substantially spatially proximate to said target position. The servo control unit (34, 600) further includes pole-compensating filtering means (126) for at least partially compensating response poles of the structural assembly (22) and its sensor assembly (30, 530)) so as to result during operation of the system in smoother switching between said substantially velocity feedback control and said position feedback control for enhancing at least one of temporal and spatially responses of the system when controlled by the servo control units (34, 600).

The present invention relates to servo systems for use in optical data readout and/or writing devices such as CD and DVD players and/or recorders. Moreover, the invention also relates to methods of servo-control for optical pickups in such CD and DVD players and/or recorders.

CD (Compact Disc) and DVD (Digital Video Disc) optical data reading and/or writing devices are now in widespread general use, for example in lap-top computers, in audio high-fidelity equipment and video equipment. There are now numerous manufacturers of such data devices with a corresponding diverse range of device implementations. However, there are some principal component parts which are substantially universally present in these data devices.

Each CD and/or DVD storage medium comprises at least one disc metallic layer sandwiched between two substantially optically transparent plastics material disc layers, the at least one metallic layer including pixel sequences disposed in an arcuate spatial arrangement centred around a central axis of the CD and/or DVD, the axis being orthogonal to the plane of the CD and/or DVD. Conventionally, each CD and/or DVD is provided with a central hole therein for engaging onto a drive mechanism for rotating the CD and/or DVD.

Each aforementioned data reading and/or writing device comprises a drive mechanism for engaging the aforementioned central hole portion of a CD and/or DVD, the mechanism including a drive motor for providing rotational torque for rotating the CD and/or DVD. Moreover, each device further comprises a movable arm often referred to as a “sled” arm. The arm is pivotally mounted at a first end thereof. Moreover, the arm is provided with a sled motor for moving the arm radially with respect to a planar surface of the CD and/or DVD engaged onto the drive mechanism; the sled motor is preferably an electromagnetic component comprising a permanent electromagnet for generating an associated magnetic field, and one or more coils of wire mechanically connected to the arm and immersed in the aforesaid magnetic field. At a second end of the arm remote from the first end thereof, there is provided an optical pickup assembly capable of being positioned proximate to the planar surface of the CD and/or DVD and actuated coarsely relative to the surface, for example for making a “long distance jump”, by way of the sled motor acting upon the arm. The pickup assembly includes a solid state laser for generating an optical interrogating radiation beam, a lens arrangement for focusing the radiation beam to generate a finely focused beam of radiation for interrogating individual data pixels formed in the aforementioned at least one metallic layer, and a photodetector for detecting fluctuations in reflected radiation corresponding to a proportion of the finely focused beam reflected from the at least one metallic layer back through the lens arrangement to the detector. A precision actuator mechanism, again most often implemented as an electromagnetic transducer, is interposed between the second end of the arm and the optical pickup assembly for use in fine position control of the pickup assembly, for example for making “short jumps” and for providing rapid adjustment of the pickup assembly to ensure accurate tracking. Each device further comprises a servo control unit for controlling the arm and the pickup assembly for moving the pickup assembly to a desired group of tracks, such movement often corresponding to a traverse of typically several mm, and for controlling the precision actuator mechanism so as to maintain the pickup assembly accurately aligned, for example to within a precision in the order of 1 μm, to a preferred serial track of data pixels on the CD and/or DVD. For achieving rapid actuation response especially when executing relatively small adjustments of pickup assembly position as the CD and/or DVD is rotated, the actuator mechanism and sled arm combination is found to be an optimal configuration to achieve substantially optimal performance.

Thus, the aforementioned servo control unit is required to control both the sled motor and the precision actuator mechanism. The unit is required not only to provide rapid track seeking, for example where the optical pickup is required to switch rapidly from a substantially innermost track to a substantially outermost track, as well as reliable track registration, for example in the presence of mechanical vibration, occasional occluding dust particles present on surfaces of the CD's and/or DVD's, and manufacturing defects in the at least one metallic layer.

Alternative designs for the aforementioned servo control unit have been previously appreciated in the art. For example, an appropriate design of such a servo control unit is described in a published U.S. Pat. No. 6,154,424; there is described a control device for locating a pickup head on a desired position, the device adapted to operate in two stages, namely in first and second stages. The first stage is concerned with utilizing velocity control to circumvent control problems associated with controlling a bi-mass system of the device. The second stage is concerned with switching the mode of device position control gradually so that the pickup head is susceptible to reaching is destination precisely whilst reducing position fluctuation problems and hence increasing an associated degree of correct tracking control. The device utilizes a feedforward control to properly correct a steady-state error arising from system characteristics or friction, a position feedback control and a switching factor for more gradually switching between modes of velocity and position control. Thus, the position and velocity of a sled motor of the device used in coarser pickup head positioning can be controlled using the control device concurrently with controlling local actuation of the head, thereby enabling the pickup head reach its destination more smoothly therefore resulting in smoother tracking control.

In another U.S. Pat. No. 5,164,931, there is described a method and apparatus for controlling position of a recording/playback head. The apparatus and method are arranged to function such that when the head reaches proximity of a desired target position, the apparatus is functional to switch from operating as a velocity control system to a position control system. By using state variables of the head, for example pertinent at a transitional time between aforesaid velocity and position control, coefficients corresponding to associated detected state variables are determined beforehand from characteristics of the head are determined. By using the determined state variables, initial values thereof upon start of position control of the apparatus are adopted, and position control is then carried out.

The inventors have appreciated that contemporary servo control units effectively employ a three-level control method, namely:
(a) when a long-distance jump of the pickup assembly is required, the method primarily involves use of the sled motor; if required, the sled motor is provided with a position control sensor to assist with coarse positioning of the pickup assembly. In order to provide rapid track access, the sled motor is preferably operated at full power; in such circumstances, to reduce overshoot of the arm, the sled motor is subject to deceleration, also referred to a braking, as the pickup assembly approaches its final desired position to within a first threshold. When the arm has been subject to braking, the method involves switching at the first threshold from primary control based around the sled motor with the actuator assembly position control being subordinate to the sled motor to velocity control based primarily around the actuator assembly where control of the sled motor is subordinate thereto; such actuator assembly velocity control utilizes PI, namely “Proportional-Integral”, feedback control in the servo control units. When the pickup assembly velocity approaches a second threshold, the method switches to employing PID, namely “Proportional-Integral-Derivative”, feedback control in the servo units for providing accurate tracking of the pickup assembly to individual sequences of pixels; and
(b) when a short-distance jump of the pickup assembly is required, the method primarily involves use of the actuator assembly operating with PI control with the sled motor subordinate thereto until the second threshold is attained, whereafter the aforesaid PID control is applied.

Thus, the method involves three distinct control regimes, namely sled with deceleration braking, PI actuator assembly velocity control and PID actuator assembly precision tracking control.

The inventors have appreciated that switching between PI and PID control with regard to the actuator assembly servo control, although representing a straightforward implementation, is not optimal and operational errors such as “radial int. clip” and “subcode timeout” known in the art are susceptible to being problems when short and long jumps are to made by the aforesaid optical device.

In devising the present invention, the inventors have endeavoured to provide at least a partial solution to the operation errors encountered in contemporary servo control units by more close attention to servo control applied to the actuator assembly providing fine position control of the pickup assembly.

A first object of the present invention is to provide an enhanced method of optical pickup assembly actuation control for providing potentially more rapid pixel track access.

A second object of the present invention is to improve reliability of optical pickup assembly position control when searching for pixel tracks.

According to a first aspect of the present invention, there is provided a servo system for controlling position of a sensor assembly in a data readout and/or writing device, the device including:
(a) at least one actuating means for spatially actuating a structural assembly and its associated sensor assembly,

the system further comprising:
(b) controlling means in communication with said at least one actuating means for controlling spatial movement of the structural assembly and the sensor assembly, the controlling means being operable:
(d) to apply substantially velocity feedback control to said at least one actuating means when the sensor assembly is substantially remote from a desired target position; and
(e) to apply substantially position feedback control to said at least one actuating means when the sensor assembly is substantially spatially proximate to said target position,

the controlling means further including pole-compensating filtering means for at least partially compensating response poles of the structural assembly and its sensor assembly so as to result during operation of the system in smoother switching between said substantially velocity feedback control and said position feedback control for enhancing at least one of temporal and spatially responses of the system when controlled by the controlling means.

The invention is of advantage in that it is capable of addressing one or more of the objects of the invention.

Preferably, in the system, the device is at least a bi-mass configuration wherein said at least one actuating means comprises:
(a) first actuating means for spatially actuating the structural assembly; and
(b) second actuating means interposed between a movable actuated region of the structural assembly and the sensor assembly for actuating the sensor assembly relative to the actuated region,

the system further being arranged such that:
(c) said controlling means is coupled in communication with the first and second actuating means for controlling spatial movement of the structural assembly and the sensor assembly,

the controlling means being operable:
(d) to apply substantially velocity feedback control to the first and second actuating means when the sensor assembly is substantially remote from the desired target position; and
(e) to apply substantially position feedback control of the first and second actuating means when the sensor assembly is substantially spatially proximate to said target position,

the controlling means further including the pole-compensating filtering means for at least partially compensating response poles of the bi-mass system so as to result during operation of the system in smoother switching between said substantially velocity feedback control and said position feedback control for enhancing at least one of temporal and spatially responses of the system when controlled by the controlling means.

Bi-mass systems each including at least two actuating means are of advantage in that they are capable of providing an optimization of large dynamic range from the first actuating means at a relatively slower response and a smaller dynamic range from the second actuating means at relatively faster response. Such a combination of characteristics is especially beneficial where a region is to be interrogated in fine detail in a methodical regular manner, for example when reading large blocks of data from a magnetic and/or optical data carrier.

Thus, preferably, the first actuating means is arranged to provide a larger spatial actuation dynamic range than the second actuating means, and the second actuating means acting upon the sensor assembly is arranged to provide a more rapid temporal response than the first actuating means acting upon the structural assembly and thereby on the second actuating means and its associated sensor assembly. Moreover, the second actuating means is preferably arranged to exhibit a smaller spatial dynamic range than the first actuating means.

The system preferably employs a relatively stable feedback function for velocity control, namely the velocity feedback control is beneficially implemented substantially as a proportional-integral PI feedback control loop. Moreover, similarly, the position feedback control is beneficially implemented substantially as a proportional-integral-differential PID feedback control loop subject to the pole-compensating filtering means. The pole-compensating filtering means is especially beneficially in that it is capable of at least partially correcting for characteristics arising from the actuating means and the structural assembly which alone in combination with PID control and/or PI control would result in unsatisfactory dynamic operating performance of the system.

In order that the system should function correctly when finely scanning areas which are a relatively large proportion of a CD and/or DVD's data recording surface areas, the controlling means is operable to render the second actuating means slave to the first actuating means in said velocity feedback control, and to render the first actuating means slave to the second actuating means in said position feedback control.

Preferably, for example in order to provide more rapid track seeking response, the controlling means is operable:
(a) to apply an acceleration process and a subsequent deceleration braking process to the first actuating means; and
(b) to switch between said velocity feedback control and said position feedback control when the sensor assembly assumes at least one of a pre-defined threshold velocity and a pre-defined spatial error between the sensor assembly and the target position.

Preferably, the system is implemented at least in part by digital logic circuits capable of being integrated into one or more integrated circuits. Therefore, in the system, data corresponding to pole responses of the structural assembly is preferably recorded digitally as pole-response data, and the controlling means is implemented digitally to utilize said pole-response data.

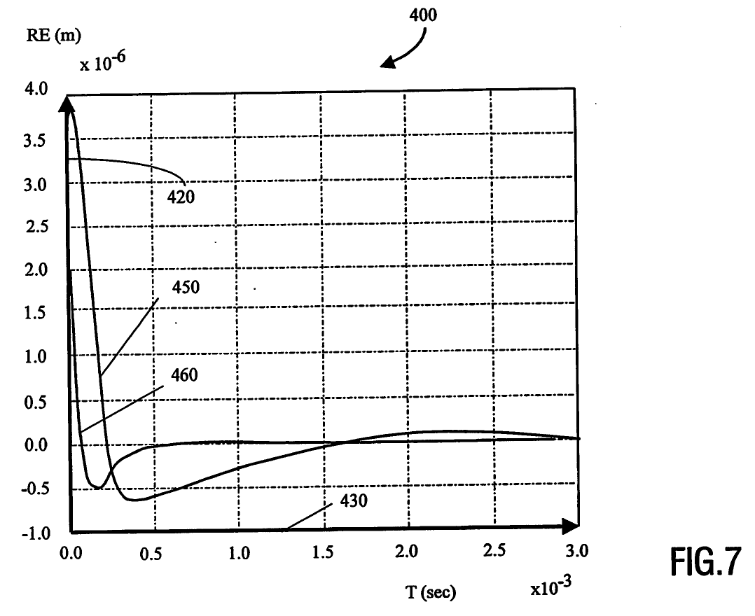

In order to provide an optimally fast response with acceptable overshoot, said controlling means is arranged to exhibit a damping factor in a range of 0.6 to 1.3 when switching between velocity feedback control and position feedback control. More preferably, for example as substantially illustrated in FIG. 7 and described later, the controlling means is arranged to be substantially critically damped when switching between the velocity feedback control and the position feedback control.

Preferably, the pole-compensating filtering means is arranged to at least partially compensate at least one open-loop response pole of the structural assembly in combination with the actuating means and the sensor assembly by applying corresponding response-zeros to the controlling means. By such a compensation process, dynamic settling characteristics of the system are susceptible to being made dependent on the controlling means rather than on the actuating means and its associated structural assembly.

The system is especially beneficial when applied the CD apparatus. Preferably, the system is incorporated into one or more of a CD reading and/or writing device for controlling the sensor assembly implemented as an optical unit within the device, the device being operable to read data from and/or write data to CDs. Additionally, or alternatively, the system is beneficially incorporated into one or more of a DVD reading and/or writing device for controlling the sensor assembly implemented as an optical unit within the device, the device being operable to read data from and/or write data to DVDs.

However, the system is beneficially adapted for alternative uses where similar precision control problems are encountered, albeit at a different physical scale to CD and/or DVD apparatus. Thus, the system is preferably adapted for controlling one or more of a pick-and-place robot, a crane and a machine tool.

In order to improve control accuracy and/or control speed, at least one of the structural assembly, the actuating means and the sensor assembly is preferably provided with spatial position, velocity, rotation and/or acceleration measuring means for use by the controlling means in controlling spatial location of the sensor assembly.

According to a second aspect of the present invention, there is provided a method of servo-control for controlling position of a sensor assembly in a data readout and/or writing device, the device including:
(a) at least one actuating means for spatially actuating a structural assembly and its associated sensor assembly,
(b) controlling means in communication with said at least one actuating means for controlling spatial movement of the structural assembly and the sensor assembly,

the method comprising the steps of arranging for the controlling means:
(d) to apply substantially velocity feedback control to said at least one actuating means when the sensor assembly is substantially remote from a desired target position; and
(e) to apply substantially position feedback control to said at least one actuating means when the sensor assembly is substantially spatially proximate to said target position,

the controlling means further including pole-compensating filtering means for at least partially compensating response poles of the structural assembly and its sensor assembly so as to result during operation of the device in smoother switching between said substantially velocity feedback control and said position feedback control for enhancing at least one of temporal and spatially responses of the device when controlled by the controlling means.

The method of the invention is of advantage in that it is capable of addressing one or more of the objects of the invention.

Preferably, the device is at least a bi-mass configuration wherein said at least one actuating means comprises:
(a) first actuating means for spatially actuating the structural assembly; and
(b) second actuating means interposed between a movable actuated region of the structural assembly and the sensor assembly for actuating the sensor assembly relative to the actuated region,

such that:
(c) said controlling means is coupled in communication with the first and second actuating means for controlling spatial movement of the structural assembly and the sensor assembly,

and such that the controlling means is operable:
(d) to apply substantially velocity feedback control to the first and second actuating means when the sensor assembly is substantially remote from the desired target position; and
(e) to apply substantially position feedback control of the first and second actuating means when the sensor assembly is substantially spatially proximate to said target position,

the controlling means further including pole-compensating filtering means for at least partially compensating response poles of the bi-mass configuration so as to result during operation of the device in smoother switching between said substantially velocity feedback control and said position feedback control for enhancing at least one of temporal and spatially responses of the device when controlled by the controlling means.

Preferable, in the method, the first actuating means is arranged to provide a larger spatial actuation dynamic range than the second actuating means, and the second actuating means acting upon the sensor assembly is arranged to provide a more rapid temporal response than the first actuating means acting upon the structural assembly and thereby on the second actuating means and its associated sensor assembly.

Preferably, the second actuating means is arranged to exhibit a smaller spatial dynamic range than the first actuating means.

Preferably, the velocity feedback control is implemented substantially as a proportional-integral PI feedback control loop. Similarly, preferably, the position feedback control is implemented substantially as a proportional-integral-differential PID feedback control loop subject to the pole-compensating filtering means.

Preferably, the controlling means is operable to render the second actuating means slave to the first actuating means in said velocity feedback control, and to render the first actuating means slave to the second actuating means in said position feedback control.

Preferably, the controlling means is operable:
(a) to apply an acceleration process and a subsequent deceleration braking process to the first actuating means; and
(b) to switch between said velocity feedback control and said position feedback control when the sensor assembly assumes at least one of a pre-defined threshold velocity and a pre-defined spatial error between the sensor assembly and the target position.

Preferably, data corresponding to pole responses of the structural assembly is recorded digitally as pole-response data, and the controlling means is implemented digitally to utilize said pole-response data.

Preferably, said controlling means is arranged to exhibit a damping factor in a range of 0.6 to 1.3 when switching between velocity feedback control and position feedback control. More preferably, the controlling means is arranged to be substantially critically damped when switching between the velocity feedback control and the position feedback control.

Preferably, the pole-compensating filtering means is arranged to at least partially compensate at least one open-loop response pole of the structural assembly in combination with the actuating means and the sensor assembly by applying corresponding response-zeros to the controlling means.

Preferably, the is applied in one or more of a CD read and/or write device for controlling the sensor assembly implemented as an optical unit within the device, the device being operable to read and/or write data to CDs. Alternatively, or additionally, the method is applied in one or more of a DVD read and/or write device for controlling the sensor assembly implemented as an optical unit within the device, the device being operable to read and/or write data to DVDs.

Preferably, in alternative fields of use where fast actuation and precise positioning are required, the method is adaptable for controlling one or more of a pick-and-place robot, a crane and a machine tool. More preferably, in the method, at least one of the structural assembly, the actuating means and the sensor assembly is provided with spatial position, velocity, rotation and/or acceleration measuring means for use by the controlling means in controlling spatial location of the sensor assembly.

It will be appreciated that features of the invention are susceptible to being combined in any combination without departing from the scope of the invention.

Embodiments of the invention will now be described, by way of example only, with reference to the following diagrams wherein:

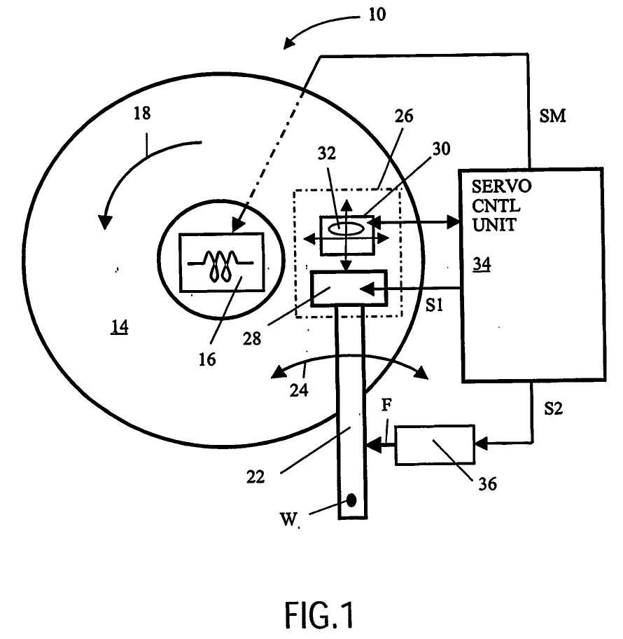

FIG. 1 is a schematic diagram of a CD and/or DVD reading and/or writing device with associated CD and/or DVD;

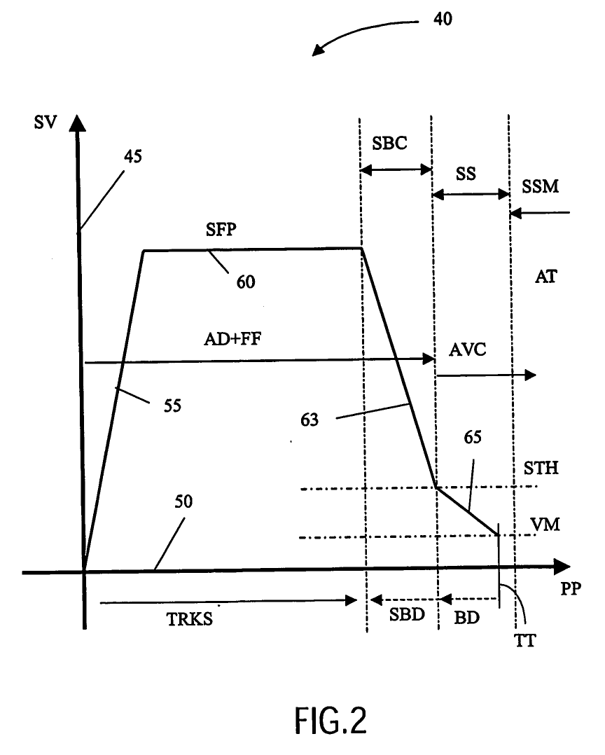

FIG. 2 is a graph illustrating optical pickup assembly radial velocity when actuated to perform a long jump in a CD and/or DVD readout device;

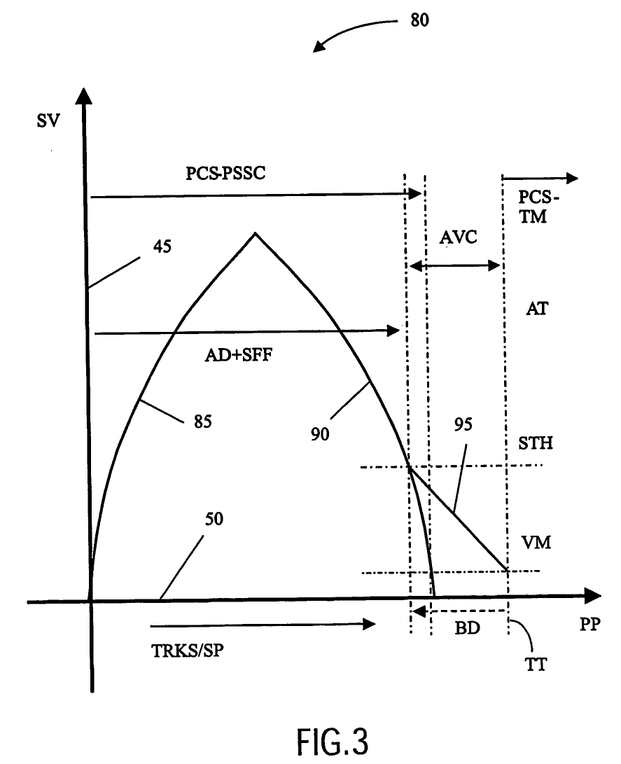

FIG. 3 is a graph illustrating optical pickup assembly radial velocity when actuated to perform a long jump in a CD and/or DVD readout device provided with a seek and position control sensor (PCS);

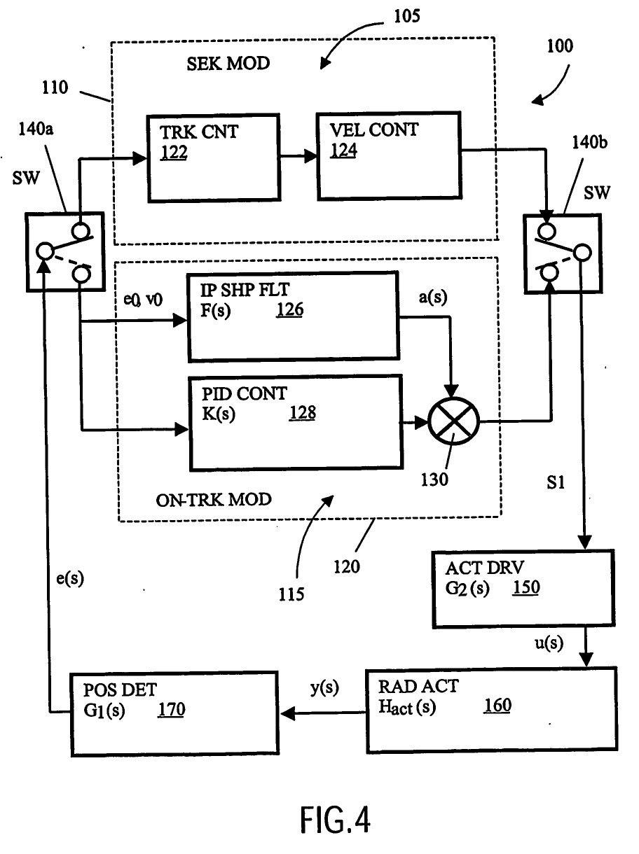

FIG. 4 is a schematic diagram of PI and PID switchable feedback control loops included within a control unit of the device of FIG. 1 for use in driving an actuator assembly of the device;

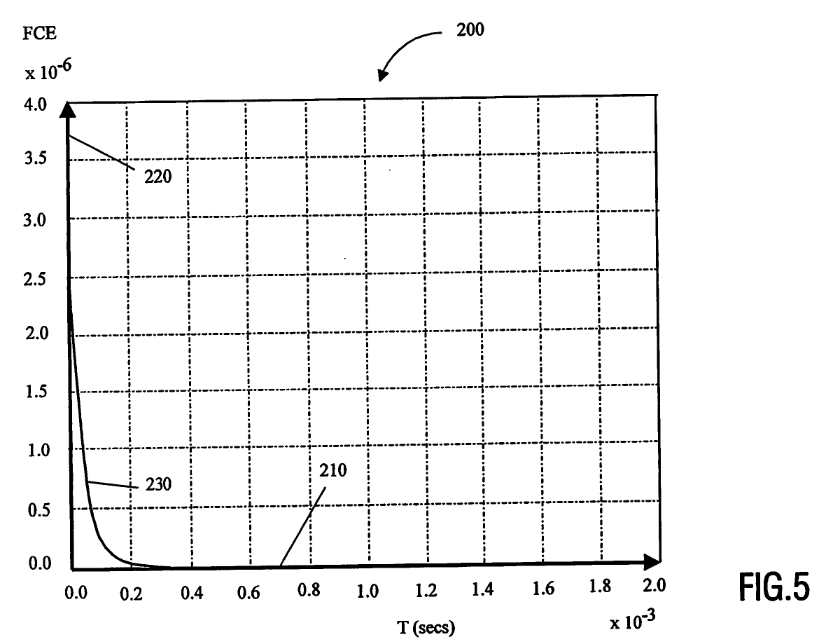

FIG. 5 is a graph illustrating settling performance of the device of FIG. 1 employing an input shaping filter in its feedback control loops as illustrated in FIG. 4;

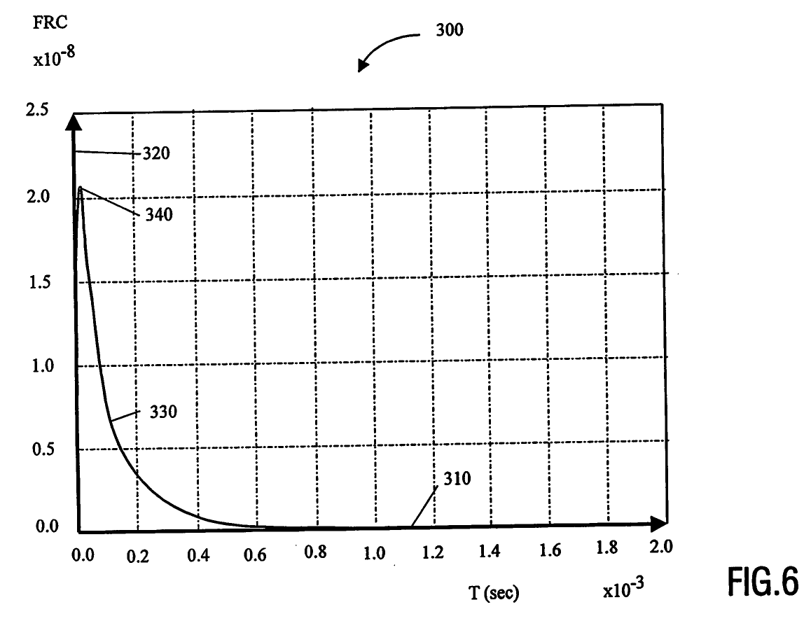

FIG. 6 is a graph illustrating settling performance of the device of FIG. 1 without an input shaping filter in its feedback control loops as illustrated in FIG. 4;

FIG. 7 is a graph illustrating transient response of the device of FIG. 1 with and without the input shaping filter of FIG. 5; and

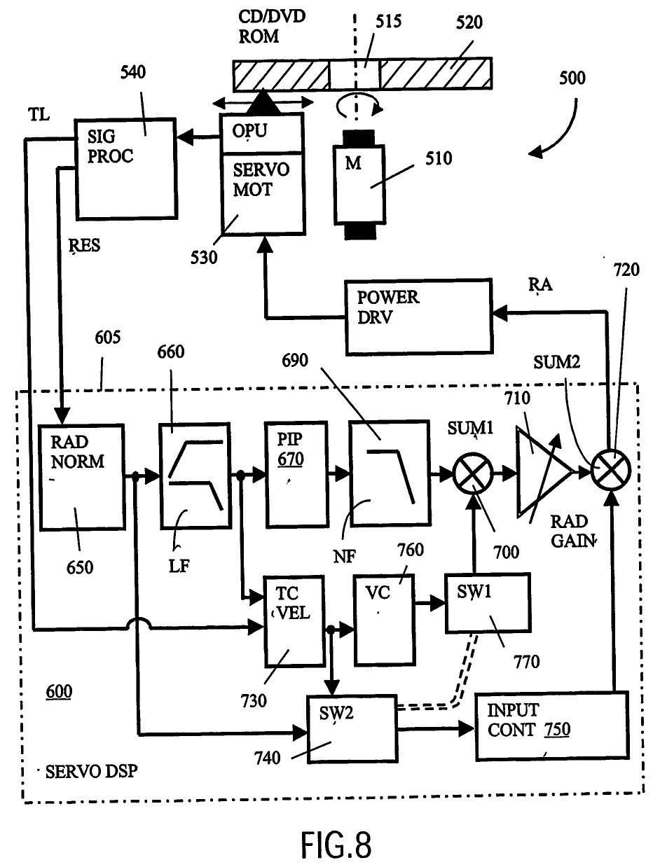

FIG. 8 is a schematic representation of a preferred embodiment of the invention suitable for implementation on a servo-control integrated circuit.

Referring to FIG. 1, there is shown a CD and/or DVD reading and/or writing device indicated generally by 10. The device 10 is operable to read pixel data from and/or write pixel data to an associated CD and/or DVD 14. The device 10 includes a drive motor 16 for rotating the CD and/or DVD 14 about its central axis in a direction as indicated by an arrow 18. The device 10 further includes an elongate arm 22 pivotally mounted at its first end about an axis W so as to be capable of rotating in a substantially radial direction relative to the CD and/or DVD 14 as indicated by an arrow 24. At the second end of the arm 22 remote from its first end, there is provided an optical sensor arrangement shown included within a dotted line 26. The sensor arrangement includes an actuator assembly 28 mechanically coupled to the second end of the arm 22 and also coupled to an optical pickup assembly 30 so as to be capable of precision actuating the pickup assembly 30 relative to the second end of the arm 22. The pickup assembly 30 includes optical components denoted by 32, for example one or more lenses, one or more lasers and one or more photodetectors. The device 10 further includes a servo control unit (SERVO CNTL UNIF) 34 for receiving a pickup signal for the pickup assembly 30 and/or outputting a write signal thereto, for outputting a first position control drive signal S1 to the actuator assembly 28, for outputting a second position control drive signal S2 to a sled motor 36 for creating an actuation force F, and for outputting a drive signal SM to the motor 16 to control its rate of rotation.

In operation, the sled motor 36 is responsible for coarsely moving the sensor arrangement in a transverse direction. Moreover, the actuator assembly 28 is operable to finely move the pickup assembly 30 to ensure accurate tracking to arcuate rows of pixels on the CD and/or DVD 14. The pickup assembly 30 is operable to generate a finely focused spot of optical radiation for interrogating the CD and/or DVD 14 and/or for writing data thereonto.

Referring next to FIG. 2, there is shown a graph indicated generally by 40. The graph 40 concerns the device 10 and its associated operating characteristics when actuating its optical pickup assembly 30 in a long jump from a first track to a second track of the CD and/or DVD 14, for example from substantially an innermost track to substantially an outermost track.

The graph 40 comprises an abscissa axis 50 corresponding to a position (PP) of the optical pickup assembly relative to the CD and/or DVD 14, and an ordinate axis 45 corresponding to an interrogation optical radiation spot velocity (SV) of the optical pickup assembly 30; the assembly position PP corresponds to track position (TRKS) of the pickup assembly 30.

The graph 40 includes a first region corresponding to actuator damping and fee-forward control (AD+FF) when the sled motor 36 is operable to actuate the arm 22. There is also shown a sled braking control region (SBC) corresponding to a sled braking distance (SBD) wherein the arm 22 and its pickup assembly 30 are decelerated in operation. Moreover, the graph 40 also includes a sled slave region (SS) wherein the pickup assembly 30 is positioned by way of the aforementioned PI actuator velocity control (AVC) provided by the actuator assembly 28; the SS region is entered when the spot velocity SV is less than a predefined speed threshold (STH) as illustrated. Moreover, the graph 40 additionally includes a brake distance (BD) wherein the pickup assembly 30 is slowed under the aforementioned PI actuator assembly velocity control. When the pickup assembly 30 is substantially within a track distance of its intended target track position (TI) whereat the pickup assembly 30 has acquired a minimum velocity (VM), the aforementioned PID control is then employed for optical pickup spot position control. Thus, the graph 40 provides an illustration of the aforementioned method.

Operation of the CD and/or DVD device will now be described in greater detail with reference to the graph 40 in FIG. 2 in conjunction with the device 10 of FIG. 1. When the optical pickup assembly 30 is required to make the large jump, the sled motor 36 is driven by the control unit 34 to accelerate the arm 22 and its pickup assembly 30 in a region denoted by 55, the sled motor 36 being driven at full power. The arm 22 and its pickup assembly 30 then achieves its final maximum velocity denoted by 60 corresponding to sled full power (SFP). At a distance denoted by 63 before the target track TT is approached, the arm 22 and its pickup assembly 30 enters the sled braking region SBC whereat the control unit 34 is operable to drive the sled motor 36 to decelerate, namely to brake, the arm 22 and its pickup assembly 30. When the velocity SV of the pickup assembly 30 falls to the threshold STH, control of the arm 22 and its pickup assembly 30 is switched within the control unit 34 to PI feedback control as denoted by 65 which causes the arm 22 and its pickup assembly 30 to decelerate at a relatively slower more precise rate as illustrated. When the arm 22 and its pickup assembly 30 attain the target track position TT, control within the control unit 34 is switched to the aforementioned PID control for achieving pixel track locking, namely actuator tracking (AT), whereat the arm and pickup assembly are actuated at the velocity minimum VM whereat the sled mode 36 operates in a sled step mode (SSM) when slaved to the actuator assembly 28 of the pickup assembly 30.

Thus, the regions 55, 60, 63 correspond to sled motor 36 operating regions where the control unit 34 is arranged to drive the actuator assembly 28 associated with the pickup assembly 30 as a slave to the sled motor 36. In contradistinction, in the region 65, the control unit 34 is arranged to slave the sled motor 36 to the actuator assembly 28 whereat PI feedback is employed. Beyond approach to the target track TT, the aforementioned PID control is employed within the control unit 34 for maintaining spot tracking on the CD and/or DVD 14.

Performance of the device 10 is susceptible to being improved by inclusion of a position sensor therein susceptible to being used to provide arm position information when seeking specific tracks. Performance of the device 10 with such a sensor is shown in FIG. 3 wherein a graph is indicated generally by 80. The device 10 is arranged to employ position control sensor (PCS) position control with square root set-point calculation (PCS-PSSC) performed in the control unit 34. Such PSC-PSSC control includes actuator damping and square root feed-forward control (AD+SFF) during initial acceleration and subsequent deceleration of the sled motor 34, corresponding to regions denoted by 85, 90, followed by actuator velocity control (AVC) in a region 95 when the pickup assembly 30 attains a velocity below the threshold STH. When the velocity minimum VM is attained, the device 10 enters its position control sensor tracking mode (PCS-TM) of operation whereat actuator tracking is employed under PID feedback in the control unit 34 with the sled motor 36 functioning as a slave.

As described in the foregoing, the inventors have appreciated that optimal design of the aforementioned PI and PID control feedback, namely for use in the AVC region and thereafter during precise tracking at the velocity minimum VM respectively, is a complex task in order to cater concurrently for stability, robustness and accuracy during tracking. For example, velocity feedback employed when the pickup velocity SV is less than the threshold STH is designed with an anticipation of providing not only a fast and precise jump characteristic for the device 10 but also smooth interfacing between an earlier region where the sled motor 36 operation dominates and a situation where actuator assembly 28 operation dominates. On account of potentially relatively large variations between individual CD and/or DVDs 14, temperature of use and friction characteristics between similar devices 10 which are mass-produced, it has hitherto been difficult to better optimize feedback control for CD and DVD reading and/or writing devices generally similar to the device 10. In conventional CD and/or DVD reading devices, actuator control is switched from aforementioned PI to PID control modes at a distance which can often be relatively uncertain and/or inappropriate giving rise to corresponding unreliability problems.

The inventors have therefore devised a better method of controlling the device 10 which is capable of providing it with a more rapid settling response and enhanced reliability when in tracking mode for interrogating and/or writing to the CD and/or DVD 14.

Referring next to FIG. 4, there is shown feedback control loops according to the invention, in schematic form indicated generally by 100, executed within the control unit 34 for use in providing feedback control of the actuator assembly 28 substantially at and after the arm 22 has reached the threshold velocity STH. The feedback control loops are capable of providing enhanced performance in comparison to contemporary feedback control loops conventionally employed in CD and/or DVD writing and/or reading devices.

The control loops 100 comprise a proportional-integral (PI) velocity control loop indicated generally by 105 and shown included within a dotted line 110, and also a proportional-integral-differential (PID) position control loop indicated generally by 115 and shown included within a dotted line 120.

The PI control loop 105 includes control functions appropriate for track seeking as in a seeking mode (SEK MOD), namely the loop 105 comprises a track counter 122 coupled effectively in series with a velocity control 124 as illustrated. In contradistinction, the PID control loop 115 includes control functions appropriate for maintaining tracking of the pickup assembly 30 to preferred radial rows of pixels, namely the loop 115 comprises an input shape filter function (IP SHP FLT) 126 coupled in parallel with a proportional-integral-differential control function (PID CONT) 128; the filter function 126 and the control function 128 are arranged to provide transfer characteristics therethrough denoted by Laplacian expressions F(s) and K(s) respectively. The functions 126, 128 are arranged to receive a common input having initial values e₀, v₀ whose significance will be elucidated later. Outputs from the functions 126, 128, for example an output a(s) from the function 126, are coupled to a summing function 130 for providing an overall output for the control loop 115.

Input and output switches (SW) 140a, 140b respectively are provided within the servo control unit 34 for selectively switching between the loops 105, 115 depending upon whether the pickup assembly 30 spot velocity (SV) is moving above or substantially at the velocity minimum VM as illustrated in FIGS. 2 and 3. The device 10 is arranged to include a driver buffer amplifier (ACT DRV) 150 for receiving the signal SI from the control unit 34 and providing an output signal u(s) for driving the actuator assembly 30; in the context of the present invention, a symbol “s” corresponds to a Laplacian operator. The drive amplifier 150 is arranged to provide a transfer characteristic therethrough denoted by a Laplacian expression G₂(s). The actuator assembly (RAD ACT) 28 itself is denoted in FIG. 4 by 160 and its transfer characteristic relating a position y(s) of the pickup assembly 30 to the output signal u(s) is denoted by a Laplacian expression H_{act}(s).

The device 10 is, with reference to FIG. 4, also provided with a position sensor 170 for sensing the position y(s) of the pickup assembly 30, thereby transducing the position y(s) to a corresponding position signal denoted by e(s), wherein the position y(s) and the parameter e(s) are related by way of a Laplacian expression G₁(s) as shown in FIG. 4.

In devising the invention, the inventors have appreciated that dynamic performance of the device 10 is beneficially taken into consideration. As the device 10 is a form of feedback system, the inventors have appreciated that feedback analysis using Laplacian representation is beneficial for achieving optimization of the device 10. In undertaking such analysis, the inventors have appreciated that several potential advantages arise by including the input shape filter 126 to supplement the PID controller 128. In particular, inclusion of the filter 126 is capable of providing smoother and more reliable switching between the control loops 105, 115 and thereby improving reliability and speed of operation of the device 10.

In order to more fully comprehend dynamic performance characteristics of the device 10, the inventors have appreciated that the device 10 illustrated with reference to FIGS. 1 and 4 is susceptible to being described in open-loop form as in Equation 1 (Eq. 1):
H(s)=H_{act}(s).G₁(s).K(s).G₂(s)=H_{act}(s).K(s).K₀ Eq. 1
wherein
H(s)=open-loop Laplacian transfer function; and
K₀=a coefficient approximating the Laplacian expressions G₁(s), G₂(s) within an operating frequency range of the device 10, namely up to several kHz.

When negative feedback is applied, as in the device 10, the position signal e(s) and actual physical position of the pickup assembly 30 is related to a system position demand parameter r(s) by Equation 2 (Eq. 2):
e(s)=r(s)−y(s) Eq. 2

The position signal e(s) is also referred as a “radial error” for closed-loop operation.

Thus, in a closed-loop negative feedback configuration utilized in the device 10, an overall closed-loop Laplacian transfer describing the device 10 is provided by Equation 3 (Eq. 3):

$$\frac{e ( s )}{r ( s )} = \frac{1}{1 + H ( s )} = \frac{N ( s )}{D ( s )} \qquad Eq . 3$$

wherein D(s) and N(s) are corresponding Laplacian expressions introduced for algebraic convenience. For non-zero initial conditions, namely where initial conditions e₀, v₀ pertain to radial position error of the pickup assembly 30 and velocity of the actuator assembly 28 respectively at an instance of switching between the functions 105, 115, Equation 3 is modified to a more comprehensive expression in Equation 4 (Eq. 4) for describing the device 10:

$$e ( s ) = \frac{N ( s )}{D ( s )} r ( s ) + \frac{{C}_{1} ( s )}{D ( s )} {e}_{0} + \frac{{C}_{2} ( s )}{D ( s )} {v}_{0} \qquad Eq . 4$$

wherein
e(s)=representation of closed-loop position error of the pickup assembly 30; and
C₁(s), C₂(s)=polynomials in the Laplacian operator “s” including terms arising from the initial conditions.

The inventors have appreciated that inclusion of the input shape filter 126 is susceptible to improving the dynamic performance of the device 10 by supplementing feedback conventionally provided solely by the PID control function 128. In devising the input shape filter 126, the inventors have appreciated that an output a(s) provided from the filter 126 is capable of being expressed as provided in a Laplacian expression of Equation 5 (Eq. 5):

$$a ( s ) = \frac{{n}_{1} ( s )}{d ( s )} {e}_{0} + \frac{{n}_{2} ( s )}{d ( s )} {v}_{0} \qquad Eq . 5$$

wherein
d(s), n₁(s), n₂(s) are Laplacian polynomials.

Thus, by combining Equations 4 and 5, the radial error e(s) is susceptible to being determinable from Equation 6 (Eq. 6):

$$e ( s ) = \frac{N ( s )}{D ( s )} r ( s ) + \frac{[ {C}_{1} ( s ) \cdot d ( s ) - {N}_{a} ( s ) \cdot {n}_{1} ( s ) ]}{D ( s ) \cdot d ( s )} {e}_{0} + \frac{[ {C}_{2} ( s ) \cdot d ( s ) - {N}_{a} ( s ) \cdot {n}_{2} ( s ) ]}{D ( s ) \cdot d ( s )} {v}_{0} \qquad Eq . 6$$

wherein
Nₐ(s) is the polynomial N(s) taking into account action of the input shape filter 126.

On account of Laplacian roots of the polynomial D(s) provided in the foregoing not necessarily corresponding to desired roots for optimal dynamic performance of the device 10, the inventors have appreciated that the input shape filter 126 is susceptible to being designed so that it will cancel all roots of the polynomial D(s) by response zeros so that the response of the feedback functions 105, 115, especially at an instance where the switches 140a, 140b switch between the functions 105, 115, is considerably improved; for example poles of the polynomial d(s) can be arranged to dominate dynamic operation of the device 10. In determining appropriate positioning of response zeros and poles, the inventors have appreciated that the Laplacian polynomial d(s) is susceptible to being represented as provided in Equation 7 (Eq. 7):
d(s)=dₘ(s).dₙ(s)=(s−α₁)(s−α₂) . . . (s−α₁).dₙ(s) Eq. 7
wherein αᵢ(i=1, 2, . . . , 2, 1) are the aforementioned desired response poles for the device 10, and a Laplacian term dₙ(s) represents a remaining part of the term d(s) after isolating the desired poles. In Equation 6, the Laplacian term Nₐ(s) is capable of being represented by a combination of:
(a) a first polynomial Nₐ′(s) whose roots are stable zeros; and
(b) a second polynomial Nₐ″(s) whose roots are unstable zeros.

Moreover, the inventors have appreciated that equating dₙ(s)'Nₐ′(s) enables Equation 6 to be conveniently expressed more fully as provided in Equation 8 (Eq. 8):

$$e ( s ) = \frac{N ( s )}{D ( s )} r ( s ) - \frac{[ {C}_{1} ( s ) \cdot {d}_{n} ( s ) \cdot {d}_{m} ( s ) + {N}_{a} ( s ) \cdot {n}_{1} ( s ) ]}{D ( s ) \cdot {d}_{n} ( s )} \cdot \frac{1}{{d}_{m} ( s )} {e}_{0} - \frac{[ {C}_{2} ( s ) \cdot {d}_{n} ( s ) \cdot {d}_{m} ( s ) + {N}_{a} ( s ) \cdot {n}_{2} ( s ) ]}{D ( s ) \cdot {d}_{n} ( s )} \cdot \frac{1}{{d}_{m} ( s )} {v}_{0} \qquad Eq . 8$$

Thus, if the roots of Equation 9 (Eq. 9) and Equation 10 (Eq. 10) include all the roots of the Laplacian polynomial D(s), the dynamic response of the device 10 is determined by pole assignment in the foregoing Laplacian term dₘ(s) of Equation 7 (Eq. 7).
C₁(s).dₘ(s)−N_{α}^{″}(s).n₁(s) Eq. 9
C₂(s).dₘ(s)−N_{α}^{″}(s).n₂(s) Eq. 10

Therefore, referring again to Equation 5 (Eq. 5), the Laplacian terms n₁(s), n₂(s) are susceptible to being represented by polynomial sequences as provided in Equations 11 and 12 (Eq. 11; Eq. 12) respectively:
n₁(s)=α₀+α₁s+ . . . +α_{q-1}s^{q-1}+α_{q}s^{q} Eq. 11
n₂(s)=b₀+b₁s+ . . . +b_{q-1}s^{q-1}+b_{q}s^{q} Eq. 12
where aᵢ and bᵢ are polynomial series coefficients.

Assuming that the roots of the Laplacian polynomial D(s) are representable as a term λ₁ wherein i=1, . . . , w, the coefficients aᵢ, bᵢ are then derivable by solving for Equation 13 (Eq. 13) represented as a matrix mapping:

$$[ \begin{matrix}{λ}_{1}^{q} & {λ}_{1}^{q - 1} & … & {λ}_{1} & 1 \\ {λ}_{2}^{q} & λ & … & λ & 1 \\ & & … & & \\ {λ}_{w}^{q} & {λ}_{w}^{q - 1} & … & {λ}_{w} & 1\end{matrix} ] [ \begin{matrix}{a}_{q} \\ {a}_{q - 1} \\ … \\ {a}_{1} \\ {a}_{0}\end{matrix} ] = [ \begin{matrix}\frac{{C}_{1} ( {λ}_{1} ) \cdot {d}_{m} ( {λ}_{1} )}{{N}_{a}^{′′} ( {λ}_{1} )} \\ \frac{{C}_{1} ( {λ}_{2} ) \cdot {d}_{m} ( {λ}_{2} )}{{N}_{a}^{′′} ( {λ}_{2} )} \\ … \\ \frac{{C}_{1} ( {λ}_{w} ) \cdot {d}_{m} ( {λ}_{w} )}{{N}_{a}^{′′} ( {λ}_{w} )}\end{matrix} ] \qquad Eq . 13$$

wherein subscripts q=w−1. When designing the input shaping filter 126, the inventors took care to ensure that Equation 4 remained proper, namely valid.

By applying Equations 1 to 13, the inventors have in practice designed the shape filter 126 to provide the device 10 with enhanced performance when its control unit 34 switches between the PI, PID functions 105, 115 respectively implemented therein. Thus, the filter 126 is susceptible to being designed to at least partially counteract the influence of a transient response exhibited by the actuator assembly 28 in combination with the arm 22 and the pickup assembly 30 and thereby improve locking performance of the device 10. In an implementation illustrated in FIG. 4, the filter 126 is capable of guaranteeing smooth switching from PI actuator velocity control to PID radial tracking locking; such smooth switching in practice, for example, can correspond to a saving of at least 10 msec where the arm 22 and its pickup assembly 30 is required to make a jump; moreover, in the order of 100 msec to 200 msec can also potentially be saved from jump retries where conventional jump failures would have occurred.

Alternative approaches for achieving smooth switching when switching between aforementioned PI and PID feedback modes include dynamically changing velocity profile. However, such approaches have been appreciated to potentially give rise to overshoot oscillations of the actuator assembly 28 at the end of a jump causing an increase in overall track seeking time. Thus, the inventors have provided the device 10 and its associated mode of operation which is not only capable of reducing overshoot but also reducing track seeking time.

In FIG. 5, there is shown a graph indicated generally by 200. The graph 200 comprises an abscissa axis 210 denoting time (T) in seconds, and an ordinate axis 220 denoting force (FRC) in arbitrary representative signal units. A curve 230 corresponds to a magnitude of the term a(s) in the time domain corresponding to a jump of the pickup assembly 28; it is representative of the rapidity of settling of the function 115 when incorporating the input shaping filter function 126 to supplement the PID control function 128 as described in the foregoing. The VM setting for FIGS. 2 and 3 with regard to FIG. 5 corresponds to a velocity of 3.2 mm/sec. In FIG. 5, it will be appreciated that settling has occurred substantially at 0.3 milliseconds.

In comparison, in FIG. 6, there is shown a graph indicated generally by 300. The graph 300 includes an abscissa axis 310 representing time (T) in seconds, and an ordinate axis 320 representing actuator force (FRC) in arbitrary representative signal units. The graph 300 relates to the device 10 devoid of the input shaping filter 126 as illustrated in FIG. 4 incorporated into its control unit 34. A curve 330 represents a settling characteristic of the device 10 and includes an initial over-shoot peak 340 followed by eventual settling within circa 0.5 milliseconds, namely almost twice as long a time duration as in FIG. 5. The peak 340 arises on account of switching between the functions 105, 115 being sub-optimal when the input shape filter 126 is not included.

A comparison of settling performance of the device 10 with and without the input shaping filter 126 is shown in a graph in FIG. 7; the graph is indicated generally by 400 and includes an abscissa axis 430 denoting time in seconds, and an ordinate axis 420 denoting radial error in metres. In the graph 400, a curve 450 corresponds to settling performance of the device 10 devoid of the input filter 126 after executing a jump at 0.0 seconds; nearly 0.7 μm overshoot occurs and final accurate position settling is not achieved to within 0.1 μm error until approaching 2.5 msec. In contradistinction, a curve 460 corresponds to settling performance of the device 10 in such circumstances where the input shaping filter 126 is included therein; nearly 0.5 μm overshoot occurs and final accurate position settling to within 0.1 μm is achieved after around 0.5 msec. It will be seen from FIG. 7 that incorporation of the input shaping filter 126 is not only capable of increasing spatial accuracy of the device 10 but also temporal accuracy thereof.

Referring finally to FIG. 8, there is shown a schematic diagram of a CD and/or DVD reading and/or writing device including an input shaping filter as described in the foregoing for assisting to achieve smoother settling when switching from velocity PI feedback to position PID feedback when implementing jumps. The device in FIG. 8 is indicated generally by 500 and includes a drive motor 510 for engaging onto a central hole 515 of a CD and/or DVD 520 for rotating the CD and/or DVD 520 in operation. The device 500 further includes a pickup unit 530 comprising a sled motor (SERVO MOT), a pivotal elongate arm coupled to the sled motor, an optical pickup assembly (OPU), and an actuator assembly (SERVO MOT) interposed between the pickup assembly (OPU) and the arm for finely adjusting position of the pickup assembly (OPU) relative to the arm. The sled motor and the actuator assembly are operable to move the pickup assembly (OPU) relative to the CD and/or DVD 520 in radial directions as indicated by arrows associated in FIG. 8 associated with the pickup assembly. An output from the optical pickup assembly (OPU) is coupled to a signal processor (SIG PROC) 540 arranged to provide tracking locking (TL) and RES signals as illustrated.

The device 500 further includes a servo-control digital signal processing integrated circuit (SERVO DSP) 600 shown included within a dotted line 605. The circuit 600 incorporates a radial normalizer (RAD NORM) 650 for receiving the aforementioned RES signal and for providing an output signal to a lead filter (LF) 660 and to a second switch (SW2) 740 as illustrated. The lead filter (LF) 660 is provided with a filtered output coupled to a PI processor (PIP) 670 and also to a first input of a track cross velocity control unit (TC VEL) 730. A second input of the velocity control unit (TC VEL) 730 is coupled to the aforementioned TL output of the signal processor 540. An output of the PI processor (PIP) 670 is connected to an input noise filter 690 whose filtered output is coupled to a first input of a first summing unit (SUM1) 700 as illustrated. An output of the velocity control unit (TC VEL) 730 is coupled to inputs of the second switch (SW2) 740 and a velocity control unit (VC) 760. Moreover, there is also provided a first switch (SW1) 770 whose inputs are connected to the control unit (VC) 760 and optionally to the second switch (SW2) 740 as shown. An output of the first switch (SW1) 770 is connected to a second input of the first summing unit (SUM1) 700. The summing unit (SUM1) 700 comprises an output which is coupled via a variable-gain radial gain amplifier (RAD GAIN) 710 to a first input of a second summing unit (SUM2) 720. Moreover, the second switch (SW2) 740 includes an additional output which is coupled to an input controller (INPUT CONT) 750 arranged to provide a corresponding output which is coupled to a second input of the second summing unit (SUM2) 720.

A radial actuation output (RA) from the second summing unit (SUM2) 720 of the servo-control circuit 600 is connected to an input of a power driver (POWER DRV) whose one or more outputs are coupled to the aforementioned sled motor and actuator assembly of the pickup unit 530. As mentioned in the foregoing, the servo-control circuit 600 is arranged to provide servo control to the pickup unit 530 switchable via the switches 740, 770 from velocity control to position control, such switching being subject to action of the aforementioned input shaping filter 126 incorporated in effect into the control circuit 600 for compensating natural poles of the device 500 to achieve more rapid and accurate settling when required to perform one or more jumps when repositioning the pickup unit 530 from one track to another on the CD and/or DVD 520.

In implementing the control circuit 600 in practice, the inventors have exercised care and attention to place poles and zeros of the lead filter 660. They have found that contemporary CD and/or DVD drive pickup radial-position control loops are substantially second order when simple PID control is employed and are therefore susceptible to overshoot and/or oscillation. Appropriate design of the lead filter 660, amongst other parts within the servo-control circuit 600, is capable of at least partially addressing such overshoot and/or oscillation. Inclusion of the aforementioned input shaping filter 126 into the servo-control circuit 600 is not found by the inventors to be impracticable with regard to requirement for memory capacity therein, for example to record control polynomial coefficients where the servo-control circuit 600 is implemented substantially digitally.

It will be appreciated that embodiments of the invention described in the foregoing are susceptible to being modified without departing from the scope of the invention.

For example, the devices 10, 600 are susceptible to being implemented in one or more of digital and analogue circuit configurations. Moreover, as described in the foregoing, the devices 10, 600 are also susceptible to being implemented, at least partially, in integrated circuit form to reduce manufacturing cost when produced in relatively large numbers.

Moreover, the invention is also susceptible to being applied in other fields of use where a bi-mass system with coarse sled actuation and fine actuator assembly control is required, for example:
(a) in computer magnetic disc drives where accurate servo positioning of one or more magnetic read/write heads relative to one or more magnetic discs is required;
(b) in robotic systems such as high-speed pick-and-place robots comprising an elongate arm with locally-actuated pickup tool mounted thereon;
(c) in crane systems employed in harbors for handling shipping containers and manoeuvring them with precision and speed; and
(d) in CNC machine tools where cutting, milling and/or grinding tools are required to be manipulated at speed with high precision.

In the cases of (b) and (c) examples above, there are preferably included at least one of accelerometers, gyroscopes, turning-rate sensors and inertial navigation units for use in providing feedback information regarding spatial proximity of movable component parts of said robotic and/or crane systems, for example for use in one of more of velocity control and position control.

Although application of the servo system and its associated method of servo-control of the invention described in the foregoing to a bi-mass mechanical system is described, it will be appreciated that they can be applied to tri-mass mechanical systems and also yet higher order mechanical systems. Moreover, the servo system of the invention is also applicable in simplified form to single mass systems.

Expressions such as “contain”, “incorporate”, “include”, “has/have” and “comprise” employed to elucidate and claim the present invention should not be construed to be exclusive to the presence of additional items. Moreover, reference to the singular is also intended to encompass the corresponding plural.

1. A servo system for controlling position of a sensor assembly (30) in a data readout and/or writing device (10, 500), the device (10, 500) including:
(a) at least one actuating means (28, 36) for spatially actuating a structural assembly(22) and its associated sensor assembly (30),
the system further comprising:
(b) controlling means (34) in communication with said at least one actuating means (28, 36) for controlling spatial movement of the structural assembly (22) and the sensor assembly (30),
the controlling means (34) being operable:
(d) to apply substantially velocity feedback control to said at least one actuating means when the sensor assembly is substantially remote from a desired target position; and
(e) to apply substantially position feedback control to said at least one actuating means when the sensor assembly is substantially spatially proximate to said target position, the controlling means further including pole-compensating filtering means (126) for at least partially compensating response poles of the structural assembly (22) and its sensor assembly (30) so as to result during operation of the system in smoother switching between said substantially velocity feedback control and said position feedback control for enhancing at least one of temporal and spatially responses of the system when controlled by the controlling means (34).

2. A system according to claim 1, wherein the device is at least a bi-mass configuration wherein said at least one actuating means (28, 36) comprises:
(a) first actuating means (36) for spatially actuating the structural assembly (22); and
(b) second actuating means (28) interposed between a movable actuated region of the structural assembly (22) and the sensor assembly (30) for actuating the sensor assembly (30) relative to the actuated region,
the system further being arranged such that:
(c) said controlling means (34) is coupled in communication with the first and second actuating means (28, 36) for controlling spatial movement of the structural assembly (22) and the sensor assembly (30),
the controlling means (34) being operable:
(d) to apply substantially velocity feedback control to the first and second actuating means (28, 36) when the sensor assembly (30) is substantially remote from the desired target position; and
(e) to apply substantially position feedback control to the first and second actuating means (28, 36) when the sensor assembly (30) is substantially spatially proximate to said target position,
the controlling means (34) further including the pole-compensating filtering means (126) for at least partially compensating response poles of the bi-mass system so as to result during operation of the system in smoother switching between said substantially velocity feedback control and said position feedback control for enhancing at least one of temporal and spatially responses of the system when controlled by the controlling means (34).

3. A system according to claim 2, wherein the first actuating means (36) is arranged to provide a larger spatial actuation dynamic range than the second actuating means (28), and the second actuating means (28) acting upon the sensor assembly (30) is arranged to provide a more rapid temporal response than the first actuating means (28) acting upon the structural assembly (22) and thereby on the second actuating means (28) and its associated sensor assembly (30).

4. A system according to claim 2, wherein the second actuating means (28) is arranged to exhibit a smaller spatial dynamic range than the first actuating means (36).

5. A system according to claim 1, wherein the velocity feedback control is implemented substantially as a proportional-integral PI feedback control loop (122, 124).

6. A system according to claim 1, wherein the position feedback control is implemented substantially as a proportional-integral-differential PID feedback control loop (128) subject to the pole-compensating filtering means (126).

7. A system according to claim 1, wherein the controlling means (34) is operable to render the second actuating means (28) slave to the first actuating means (36) in said velocity feedback control, and to render the first actuating means (36) slave to the second actuating means (28) in said position feedback control.

8. A system according to claim 1, wherein the controlling means (34) is operable:
(a) to apply an acceleration process and a subsequent deceleration braking process to the first actuating means (36); and
(b) to switch between said velocity feedback control and said position feedback control when the sensor assembly (30) assumes at least one of a pre-defined threshold velocity and a pre-defined spatial error between the sensor assembly (30) and the target position.

9. A system according to claim 1, wherein data corresponding to pole responses of the structural assembly is recorded digitally as pole-response data, and the controlling means (34, 600) is implemented digitally to utilize said pole-response data.

10. A system according to claim 1, wherein said controlling means (34) is arranged to exhibit a damping factor in a range of 0.6 to 1.3 when switching between velocity feedback control and position feedback control.

11. A system according to claim 10, wherein the controlling means (34) is arranged to be substantially critically damped when switching between the velocity feedback control and the position feedback control.

12. A system according to claim 1, wherein the pole-compensating filtering means (126) is arranged to at least partially compensate at least one open-loop response pole of the structural assembly (22) in combination with the actuating means (28, 36) and the sensor assembly (30) by applying corresponding response-zeros to the controlling means (34).

13. A system according to claim 1 incorporated into one or more of a CD reading and/or writing device (10, 500) for controlling the sensor assembly (30) implemented as an optical unit (32) within the device, the device (10, 500) being operable to read data from and/or write data to CDs (14, 520).

14. A system according to claim 1 incorporated into one or more of a DVD reading and/or writing device (10, 500) for controlling the sensor assembly (30) implemented as an optical unit (32) within the device (10, 500), the device (10, 500) being operable to read data from and/or write data to DVDs (14, 520).

15. A system according to claim 1, the system being adapted for controlling one or more of a pick-and-place robot, a crane and a machine tool.

16. A system according to claim 1, wherein at least one of the structural assembly (22), the actuating means (28, 36) and the sensor assembly (30) is provided with spatial position, velocity, rotation and/or acceleration measuring means for use by the controlling means (34) in controlling spatial location of the sensor assembly (30).

17. A method of servo-control for controlling position of a sensor assembly (30) in a data readout and/or writing device (10, 500), the device (10, 500) including:
(a) at least one actuating means (28, 36) for spatially actuating a structural assembly (22) and its associated sensor assembly (30),
(b) controlling means (34) in communication with said at least one actuating means (28, 36) for controlling spatial movement of the structural assembly (22) and the sensor assembly (30),
the method comprising the steps of arranging for the controlling means (34):
(d) to apply substantially velocity feedback control to said at least one actuating means (28, 36) when the sensor assembly (30) is substantially remote from a desired target position; and
(e) to apply substantially position feedback control to said at least one actuating means (28, 36) when the sensor assembly (30) is substantially spatially proximate to said target position,
the controlling means (34) further including pole-compensating filtering means (126) for at least partially compensating response poles of the structural assembly (22) and its sensor assembly (30) so as to result during operation of the device (10, 500) in smoother switching between said substantially velocity feedback control and said position feedback control for enhancing at least one of temporal and spatially responses of the device (10, 500) when controlled by the controlling means (34).

18. A method according to claim 17, wherein the device (10, 500) is at least a bi-mass configuration wherein said at least one actuating means (28, 36) comprises:
(a) first actuating means (36) for spatially actuating the structural assembly (22); and
(b) second actuating means (28) interposed between a movable actuated region of the structural assembly (22) and the sensor assembly (30) for actuating the sensor assembly (30) relative to the actuated region,
such that:
(c) said controlling means (34) is coupled in communication with the first and second actuating means (28, 36) for controlling spatial movement of the structural assembly (22) and the sensor assembly (30),
and such that the controlling means (34) is operable:
(d) to apply substantially velocity feedback control to the first and second actuating means (28, 36) when the sensor assembly (30) is substantially remote from the desired target position; and
(e) to apply substantially position feedback control of the first and second actuating means (28, 36) when the sensor assembly (30) is substantially spatially proximate to said target position,
the controlling means (34) further including pole-compensating filtering means (126) for at least partially compensating response poles of the bi-mass configuration so as to result during operation of the device in smoother switching between said substantially velocity feedback control and said position feedback control for enhancing at least one of temporal and spatially responses of the device when controlled by the controlling means (34).

19. A method according to claim 18, wherein the first actuating means (36) is arranged to provide a larger spatial actuation dynamic range than the second actuating means (28), and the second actuating means (28) acting upon the sensor assembly (30) is arranged to provide a more rapid temporal response than the first actuating means (36) acting upon the structural assembly (22) and thereby on the second actuating means (28) and its associated sensor assembly (30).

20. A method according to claim 18, wherein the second actuating means (28) is arranged to exhibit a smaller spatial dynamic range than the first actuating means (36).

21. A method according to claim 17, wherein the velocity feedback control is implemented substantially as a proportional-integral PI feedback control loop (122, 124).

22. A method according to claim 17, wherein the position feedback control is implemented substantially as a proportional-integral-differential PID feedback control loop (128) subject to the pole-compensating filtering means (126).

23. A method according to claim 17, wherein the controlling means (34) is operable to render the second actuating means (28) slave to the first actuating means (36) in said velocity feedback control, and to render the first actuating means (36) slave to the second actuating means (28) in said position feedback control.

24. A method according to claim 17, wherein the controlling means (34) is operable:
(a) to apply an acceleration process and a subsequent deceleration braking process to the first actuating means; and
(b) to switch between said velocity feedback control and said position feedback control when the sensor assembly (30) assumes at least one of a pre-defined threshold velocity and a pre-defined spatial error between the sensor assembly (30) and the target position.

25. A method according to claim 17, wherein data corresponding to pole responses of the structural assembly (22) is recorded digitally as pole-response data, and the controlling means (34) is implemented digitally to utilize said pole-response data.

26. A method according to claim 17, such that said controlling means (34) is operable to exhibit a damping factor in a range of 0.6 to 1.3 when switching between velocity feedback control and position feedback control.

27. A method according to claim 26, wherein the controlling means (34) is arranged to be substantially critically damped when switching between the velocity feedback control and the position feedback control.

28. A method according to claim 17, wherein the pole-compensating filtering means (126) is arranged to at least partially compensate at least one open-loop response pole of the structural assembly (22) in combination with the actuating means (28, 36) and the sensor assembly (30) by applying corresponding response-zeros to the controlling means (34).

29. A method according to claim 17 applied in one or more of a CD read and/or write device (10) for controlling the sensor assembly (30) implemented as an optical unit (32) within the device (10, 500), the device (10, 500) being operable to read and/or write data to CDs (520).

30. A method according to claim 17 applied in one or more of a DVD read and/or write device (10, 500) for controlling the sensor assembly (30) implemented as an optical unit (32) within the device (10, 500), the device (10, 500) being operable to read and/or write data to DVDs (520).

31. A method according to claim 17 adapted for controlling one or more of a pick-and-place robot, a crane and a machine tool.

32. A method according to claim 17, wherein at least one of the structural assembly (22), the actuating means (28, 36) and the sensor assembly (30) is provided with spatial position, velocity, rotation and/or acceleration measuring means for use by the controlling means (34) in controlling spatial location of the sensor assembly (34).
